(19) United States
(12) Patent Application Publication
(10) Pub. No.: US 2011/0157592 A1
(43) Pub. Date: Jun. 30, 2011

(54) SURFACE PLASMON RESONANCE UNIT AND INSPECTION SYSTEM USING THE SAME

(75) Inventors: Jia-Huey Tsao, Taipei County (TW); Jau-Jiu Ju, Hsinchu County (TW); Hsueh-Ching Shih, Taipei County (TW); Chun-Min Su, Taichung County (TW); Hung-Yueh Chen, Taichung County (TW); Kuo-Chi Chiu, Hsinchu County (TW); Chih-Cheng Feng, Taipei City (TW); Sheng-Li Chang, Hsinchu County (TW); Hsing-Cheng Yu, Taipei City (TW)

(73) Assignee: Industrial Technology Research Institute, Hsinchu (TW)

(21) Appl. No.: 12/980,094

(22) Filed: Dec. 28, 2010

(30) Foreign Application Priority Data
Dec. 31, 2009 (TW) 098146147

(51) Int. Cl. G01N 21/55; G01N 1/10

(52) U.S. Cl. 356/445; 356/246

(57) ABSTRACT

The present invention provides a surface plasmon resonance (SPR) unit having at least one microfluidic channel with grating structures embedded in so that a grating-coupled surface plasmon resonance can be induced by an incident light while fluid in the microfluidic channel contacts or flows through the grating area. The induced variation of optical signal due to the SPR effect is analyzed for performing bio-screening and assay of bioaffinity reaction. Meanwhile, present invention further provides an SPR inspection system possessing a rotation power to the SPR unit such that the SPR unit is capable of rotating and thereby generating a centrifugal force for driving the flow inside the microfluidic channels so as to achieve the label-free and high throughput SPR inspection system with low-cost.

### TECHNICAL FIELD

The present disclosure relates to an optical inspection technique, and more particularly, to a surface plasmon resonance unit configured with microfluidic channels and light gratings and the inspection system using the same.

### TECHNICAL BACKGROUND

In biomolecular interaction analysis (BIA), the development of biochip technology is a major thrust of the rapidly growing biotechnology industry and encompasses a very diverse range of research efforts including genomics and proteomics, which is considered to be the key factor bridging between the genomics and proteomics. The biochips, generally being classified as array chips and microfluidic chips, which are essentially miniaturized laboratories that can perform hundreds or thousands of simultaneous biochemical reactions with respect to gene expression or biomolecular signal transduction, enabling researchers to quickly screen large numbers of biological analytes for a variety of purposes, from disease diagnosis to detection of bioterrorism agents. Typically in a microfluidic chip, fluids are enables to flow in microchannels between storage wells, detection regions and waste wells, which are used in different biochemical reactions. It is noted that the flowing of the fluids in the microfluidic chip is usually being driven by the use of pumps, such as syringe pump and peristaltic pump. Nevertheless, in some microfluidic chip, the fluids are driven to flow not by any of the aforesaid pumps, but by a centrifugal force generated from the rotation of the microfluidic chip driven by a motor. Moreover, the assays performed in biochips are primarily analyzed by means of fluorescent detections, light absorbance detections or color reaction detections.

Recently, the rotatable disc-like microfluid chips that utilizes centrifugal forces for inducing fluid to flow inside the microfluidic channels thereon are becoming more and more popular, since the flowing of fluids in a microfluidic chip relating to their transportation, control and treatment are determined and governed by the microfluidic channels formed thereon for integrating a plurality of complex test procedures including the procedures of sample preparation, mixing, separation, quantifying, switching and reaction detection, etc., to be performed on the microfluidic chip, and thereby, enabling any assay to be performed on the microfluidic chip in an easy and rapid manner with less amount of reaction agents used, and further saving the microfluidic chip from being configured with complex structures for fluid control and detection and thus from high manufacture cost, as those conventional microfluidic chips did. One example is illustrated in U.S. Pat. No. 5,994,150, which discloses an optical assaying system having a rotatable sensor disk with multiple sensing regions coated with indicator dyes sensitized to a variety of substances. It is noted that the indicator dyes used in the aforesaid optical assay system are fluorescent materials and there is no light grating structures being adopted in the system as well.

However, it could be very problematic in the use of fluorescent dyes as detection agents in microfluidic chips, since it will have to deal with problems including the triviality of fluorescent label assignment, the difficulty for labeling signal molecules, the inevitable fluorescence decaying, the difficulty for providing kinetic information relating to biomolecule interaction in a real-time manner, and so on. Therefore, label-free biosensing methods are much more in demand. Among those label-free biosensing methods that are currently available, the surface plasmon resonance (SPR) method is most valued for its high sensitivity. One example is illustrated in U.S. Pat. No. 7,295,320, in which the arrangement is characterized in that the detector unit is based on surface plasmon resonance (SPR) and is capable of measuring the characteristics of analytes by observing the reactions happening within the microcavities, i.e. SPR-MCs, on a rotatable microfluidic disc having micro-cavity structure formed thereon. In addition, there is another example illustrated in U.S. Pat. Pub. No. 20060187459 which is a biochip scanner having a prism and microchannel structure formed therein. In the aforesaid biochip scanner, fluid is transported inside the microchannel structure by centrifugal force created by the spinning of the biochip scanner while enabling a photosensor embedded in the biochip scanner to detect a detection beam containing information relating to the characteristic of an analyte as the detection beam is resulting from the projection of a beam upon the fluid flowing in the microchannel structure that contains the analyte.

It is noted that the surface plasmon resonance (SPR) method, not matter it adopts SPR-MC or prism, is more complex, more costly that it is not suitable to be applied in any mass production process.

### TECHNICAL SUMMARY

The present disclosure relates to a surface plasmon resonance (SPR) unit having at least one microfluidic channel with grating structures embedded therein so that a grating-coupled surface plasmon resonance can be induced by an incident light while fluid in the microfluidic channel contacts or flows through the grating area. The induced variation of optical signal due to the SPR effect is analyzed for performing monitoring of bio-affinity reaction.

The present disclosure relates to a surface plasmon resonance (SPR) unit, that is substantially a substrate configured with microchannels for fluid transportation and grating-coupled biosensors so as to be used for achieving tasks including fluid transportation, reaction agent mixing, biochemical reaction enabling, label-free detection, etc. An innovative multi-layer structure is adopted for forming the grating and microchannels, which is performed by applying a simple machining process upon a micro/nano composite material with the use of double-sided adhesive interlayer. Accordingly, the so-formed grating and microchannels are capable of overcoming the overflowing and overlaying problems troubling on the microchannel/grating nano-structure being formed during the conventional gluing process.

In addition, the present disclosure relates to a SPR inspection system, in which the fluid containing analyte is driven to flow inside a microchannel structure by a centrifugal force while using an optical modulation mechanism to detect the grating-coupled SPR effect and thus analyzing the induced variations of optical signal for bio-screening and kinetic monitoring performance.

In an embodiment of the present disclosure, a SPR unit is provided, which comprises: a microchannel unit, having at least one microchannel; and at least one grating structure, each configured with a metal layer and each being respectively disposed inside the at least one microchannel.

Moreover, in another embodiment of the present disclosure, a SPR inspection system is disclosed, which comprises: at least one SPR unit, further comprising: a microchannel unit, having at least one microchannel; and at least one grating structure, each configured with a metal layer and each being respectively disposed inside the at least one microchannel; a light source module, for projecting an incident beam onto the at least one SPR unit for generating a detection beam accordingly; an optical detection module, for receiving the detection beam; and a rotation unit, for carrying the at least one SPR unit and capable of performing a rotation movement for bringing along the at least one SPR unit to rotate accordingly; wherein, the microchannel unit further comprises: a microchannel layer, configured with a first surface, a second surface, and at least one groove; a cover layer, disposed on the first surface; and a substrate, disposed on the second surface while enabling the at least one grating structure to be formed on the substrate at a position corresponding to the at least one groove.

In addition, in another embodiment, the microchannel unit further comprises: a substrate, having at least one groove formed thereon while enabling the bottom of each groove to be formed with the corresponding grating structure; and a cover layer, disposed on the substrate

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A is a three-dimensional diagram showing a surface plasmon resonance (SPR) unit according to a first embodiment of the present disclosure.

FIG. 1B is an A-A cross-section diagram showing the microchannel structure formed on the SPR unit in the first embodiment of the present disclosure.

FIG. 1C is an exploded view of the SPR unit of FIG. 1A.

FIG. 2 is a schematic diagram showing the bottom of a cover layer formed in the SPR unit of FIG. 1A.

FIG. 3A is a three-dimensional diagram showing a surface plasmon resonance (SPR) unit according to a second embodiment of the present disclosure.

FIG. 3B is a B-B cross-section diagram showing the microchannel structure formed on the SPR unit in the second embodiment of the present disclosure.

FIG. 3C is a cross-section diagram showing the microchannel structure formed on the SPR unit in a third embodiment of the present disclosure.

FIG. 4 is a schematic diagram showing a substrate used in the SPR unit of FIG. 3A.

FIG. 5 is a schematic diagram showing a SPR inspection system according to an embodiment of the present disclosure.

FIG. 6A and FIG. 6B are schematic views of an angle adjustment device used in the present disclosure.

FIG. 6C is a schematic diagram showing how an angle adjustment device is being arranged according to an embodiment of the present disclosure.

FIG. 7 is a schematic diagram showing a driver for the angle adjustment device of the present disclosure.

FIG. 8 is a schematic diagram showing how a SPR unit is arranged according to an embodiment of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

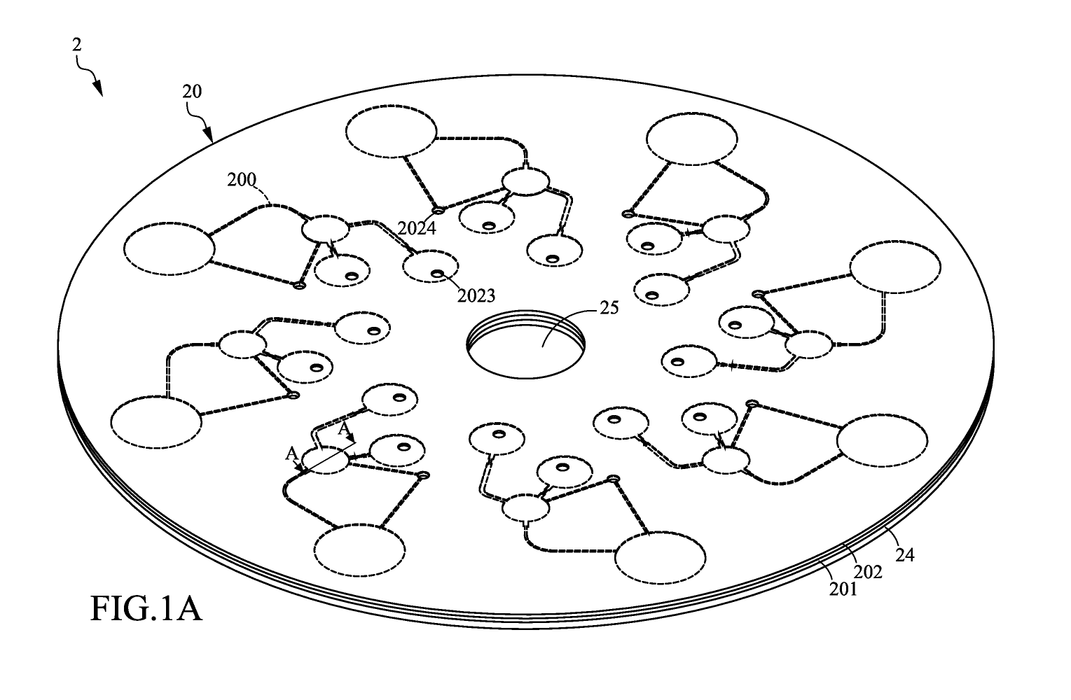

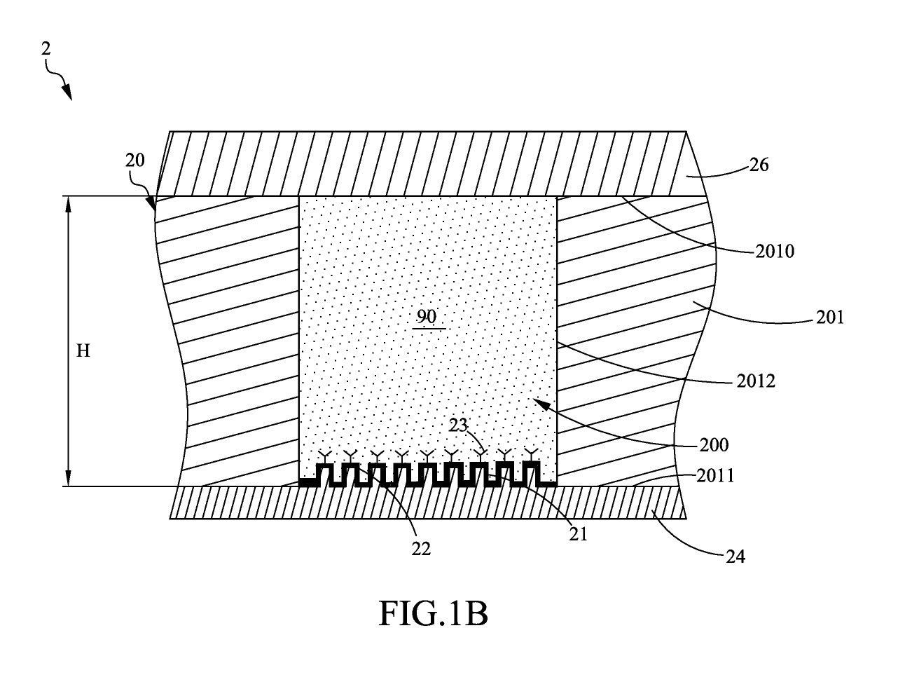

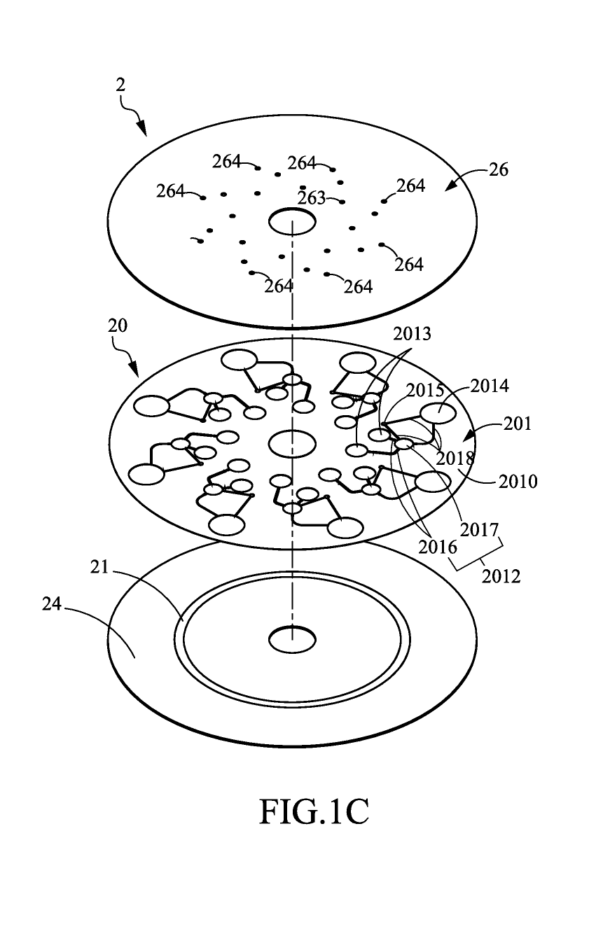

Please refer to FIG. 1A and FIG. 1B, which are a three-dimensional diagram showing a surface plasmon resonance (SPR) unit according to a first embodiment of the present disclosure; and an A-A cross-section diagram showing the microchannel structure formed on the SPR unit of FIG. 1A. As shown in FIG. 1A and FIG. 1B, the SPR unit 2 comprises: a microchannel unit 20 and at least one grating structure 21, in which the microchannel unit is further composed of at least one microchannel 200 for a fluid 90 to flow therein, whereas the fluid 90 can contain analytes such as antigens. In this embodiment, the depth H of the microchannel 200 is ranged between 20 μm and 200 μm, but is not limited thereby. Moreover, each of the at least one grating structure 21, being configured with a metal layer 22, is disposed inside its corresponding microchannel 200 selected from the at least one microchannel 200, whereas the metal layer 22 is a metal nano-thin film which can be made of gold, silver, or aluminum, but is not limited thereby. In this embodiment, the metal layer 22 is a gold nano-thin film of about 45 nm to 50 nm in thickness, and is provided for a bio material 23 like antibodies to be immobilized thereon by the use of a conventional biochemical conjugation process.

Please refer to FIG. 1C, which is an exploded view of the SPR unit of FIG. 1A. As shown in FIG. 1C, the SPR unit 2 is formed as a three-layered structure, whereas the microchannel unit 20 is configured with a microchannel layer 201 as one of the three layers, and the microchannel layer 201 has at least one groove 2012 formed thereon. In this embodiment, the microchannel layer 201 is a double-sided adhesive layer, i.e. there are adhesive materials formed respectively on its first surface 2010 (top surface) and second surface 2011 (bottom surface). Moreover, there is a cover layer 26, provided for covering the microchannel layer 201, which can be made of polycarbonate (PC) acrylic or other plastics, but is not limited thereby. It is noted that there are a plurality of grooves 2012 formed on the microchannel layer 201 in a manner that each groove 2012 is formed penetrating the microchannel layer 201 for enabling the first surface 2010 to communicate with the second surface 2011 therethrough. In addition, the number of the grooves 2012 being formed is determined according to actual test requirement. As the embodiment shown in FIG. 1C, each groove 2012 is further comprised of: at least one manifold 2016; and at least one inspection region 2017 connected to the at least one manifold 2016. Moreover, each groove 2012 is connected to at least one storage well 2013 and at least one waste fluid well 2014, vent holes 2015 and other wells. In this embodiment, the inspection region 2017 of the manifold 2016 is connected to the waste fluid well 2014 and the vent hole 2015 by the channel 2018 and simultaneously is further connected to the storage well 2013 by the manifold 2016. It is noted that each groove 2012 can be formed with only the manifold 2016, or only with the inspection region 2017.

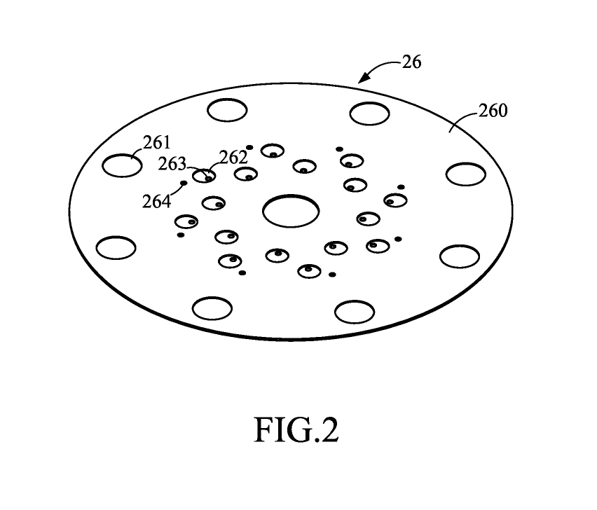

Similarly, each storage well 2013 as well as each waste fluid well 2014 is penetrating the microchannel layer 201 for enabling the first surface 2010 to communicate with the second surface 2011 therethrough. Please refer to FIG. 1C and FIG. 2, in which FIG. 2 is a schematic diagram showing the bottom of a cover layer formed in the SPR unit of FIG. 1A. As shown in FIG. 1C, the bottom 260 of the cover layer 26 is arranged facing toward the first surface 2010 of the microchannel layer 20 so as to be covered thereon. For increasing the capacity for containing the waste fluid as well as the working fluid, there are expansion slots 261, 262 formed on the cover layer 26 at positions respectively corresponding to the at least one waste fluid well 2014 and the at least one storage well 2014. Thereby, the capacities of the waste fluid well 2014 and the storage well 2013 are increased by the formation of the corresponding expansion slots 261, 262 as soon as the cover layer 26 is disposed on top of the microchannel layer 201. In addition, there should be a loading well 263 to be formed on the cover layer 26 at a position right on or at the neighborhood of the expansion slot 262 corresponding to the storage well 2013, and also there should be at least one vent hold hole 264 to be formed on the cover layer 26 at a position corresponding to the vent hole 2015 of the groove 2012.

In addition to the cover layer which is disposed on the first surface 2010 of the microchannel layer 201 while being fixedly adhered thereto, there is a substrate 24 being adhered to the second surface 2011, whereas the at least one grating structure 21 is formed on the substrate. By sandwiching the microchannel layer 201 between the cover layer 26 and the substrate 24, the at least one groove 2012 can be shaped into the at least one microchannel configured with grating structure that is provided for the fluid to flow therein. Moreover, each waste fluid well 2014 along with its corresponding expansion slot 261 can be shaped into an accommodation space for storing waste fluid that is drawn by centrifugal forces; and each storage well 2013 along with its corresponding expansion slot 262 can be shaped into another accommodation space for storing unused fluid. Although the microchannel layer 201 shown in this embodiment is a double-sided adhesive layer, but is not limited thereby, that is, it can be replaced by a substrate having a top surface 2010 and a bottom surface 2011 that are coated with adhesives, such as epoxy resin or UV adhesive. Moreover, the substrate 24 can be made of PC or acrylic, but is not limited thereby. It is noted that the expansion slots 261, 262 that are formed corresponding to the waste fluid well 2014 and the storage well 2013 are not the necessities for the present disclosure, but can be formed if required.

As shown in FIG. 1A, there is an opening 25 formed at the center of the SPR unit 2, that is provided for a rotation axle to pass therethrough so as to drive the SPR unit 2 to rotate with the rotation of the rotation axle. In addition, although the SPR unit 2 shown in this embodiment is a disc-like structure, but it is not limited thereby, i.e. the SPR unit 2 of the present disclosure can be shaped like a rectangle or other polygons.

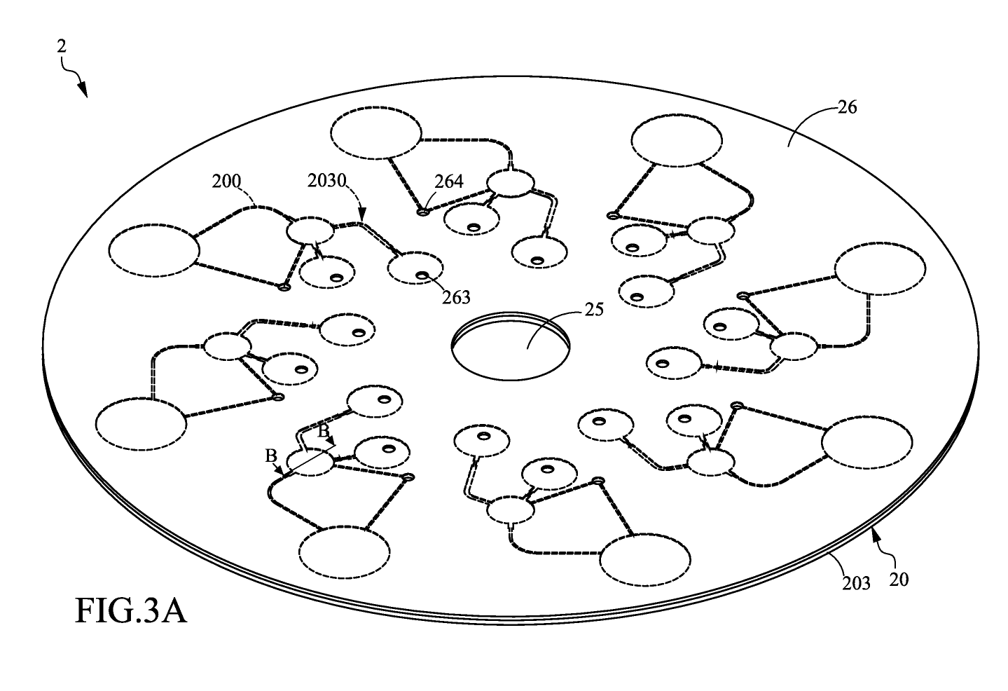

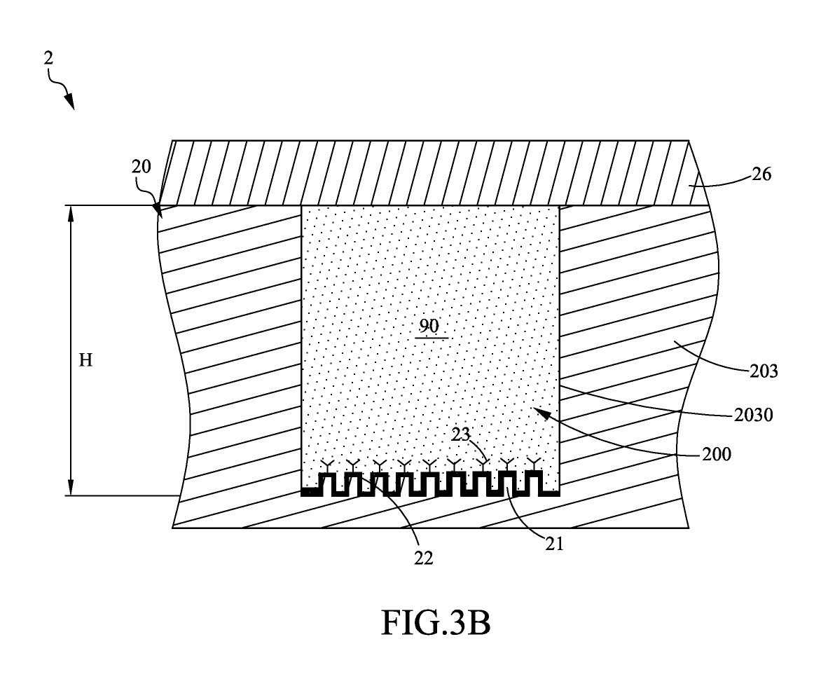

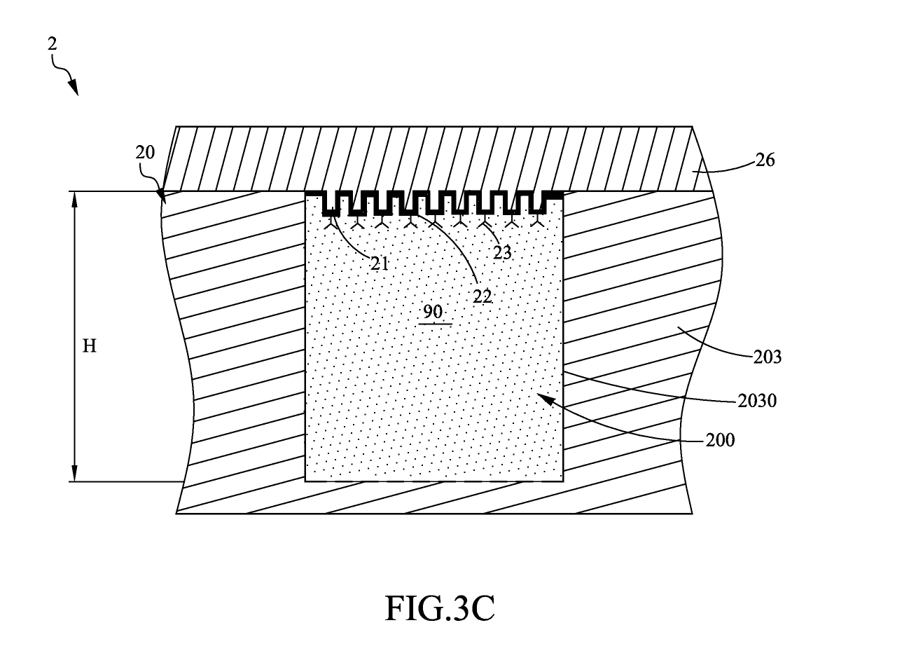

Please refer to FIG. 3A and FIG. 3B, which are a three-dimensional diagram showing a surface plasmon resonance (SPR) unit according to a second embodiment of the present disclosure; and a B-B cross-section diagram showing the microchannel structure formed on the SPR unit in the second embodiment. In this second embodiment, the SPR unit 2, being configured with a cover layer 26, a microchannel unit 20 and at least one grating structure 21 with a metal layer 22, is different from the first embodiment in that: the SPR unit 2 of the second embodiment is a two-layered structure, whereas the microchannel unit 20 is configured with a substrate 203 as one of the three layers. As shown in FIG. 3A, the substrate 203 has at least one groove 2030 formed thereon while enabling the grating structure 21 to be formed on the bottom of each groove 2030. In this embodiment, the substrate 203 can be made of PC or acrylic, but is not limited thereby. Moreover, each groove 2030 can be integrally formed with its corresponding grating structure 21.

In this second embodiment, the cover layer 26 is disposed on the substrate 203 while being fixedly adhered thereto, whereas the adhesion can be enabled by the use of UV adhesives, but is not limited thereby Similarly, the cover layer 26 can also be made of PC or acrylic, but is not limited thereby. By the covering of the cover layer 26 on the substrate 203, the at least one groove 2030 is shaped into the at least one microchannel 200, provided for the fluid 90 to flow therein. Please refer to FIG. 3C, which is a cross-section diagram showing the microchannel structure formed on the SPR unit in a third embodiment of the present disclosure. The formation of the grating structure of the third embodiment is different from the grating structure 21 with metal layer 22 shown in FIG. 32B that is formed in the bottom of the groove 2030. In this third embodiment, each grating structure 21 with metal layer 22 is formed on the cover layer 26 at a position corresponding to the at least one groove 2030.

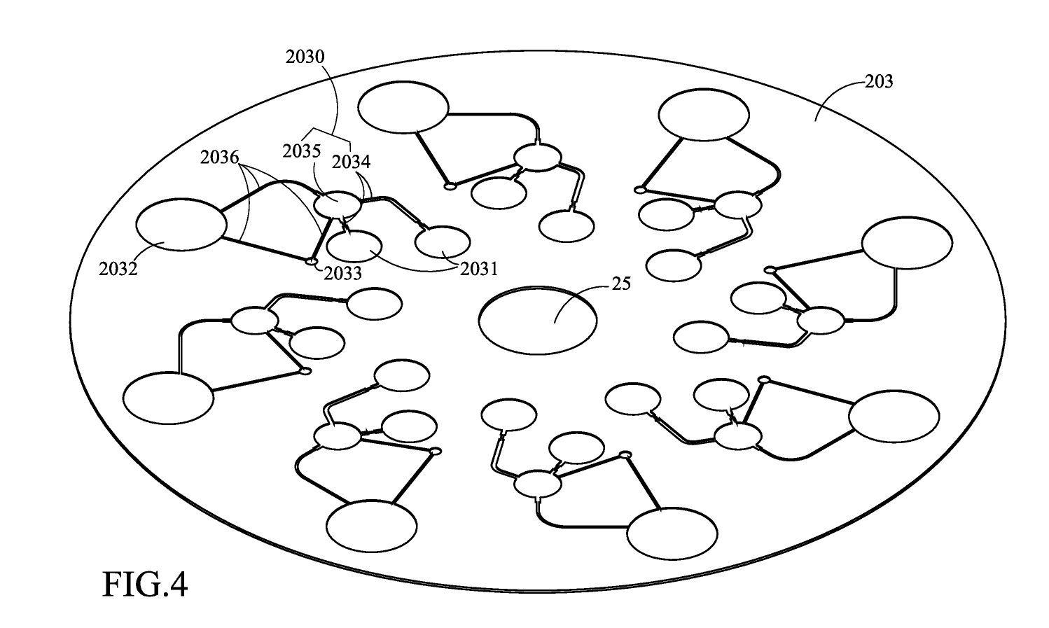

Please refer to FIG. 4, which is a schematic diagram showing a substrate used in the SPR unit of FIG. 3A. As shown in FIG. 4, each groove 2030 is further comprised of: at least one manifold 2034; and at least one inspection region 2035 connected to the at least one manifold 2016. Moreover, each groove 2030 is connected to at least one storage well 2031 and at least one waste fluid well 2032, vent holes 2033 and other wells. In this embodiment, the inspection region 2035 of the manifold 2034 is connected to the waste fluid well 2032 and the vent hole 2033 by the channel 2036 and simultaneously is further connected to the storage well 2031 by the manifold 2034. It is noted that each groove 2030 can be formed with only the manifold 2034, or only with the inspection region 2035. Similar to those shown in FIG. 2, there are expansion slots 261, 262 formed on the cover layer 26 at positions respectively corresponding to the at least one waste fluid well 2032 and the at least one storage well 2031. Thereby, the capacity of the waste fluid well 2032 as well as the storage well 2031 is increased by the formation of the expansion slots 261, 262. In addition, there should be a loading well 263 to be formed on the cover layer 26 at a position corresponding to the expansion slot 262 of the storage well 2031, and also there should be at least one vent hold hole 264 to be formed on the cover layer 26 at a position corresponding to the vent hole 2033 of the groove 2030. It is noted that the at least one waste fluid well 3032 and the at least one storage well 2031 are not being formed penetrating the substrate 203. Moreover, the expansion slots 261, 262 that are formed corresponding to the waste fluid well 2031 and the storage well 2032 are not the necessities for the present disclosure, but can be formed if required.

As shown in FIG. 3A, there is an opening 25 formed at the center of the SPR unit 2, that is provided for a rotation axle to pass therethrough so as to drive the SPR unit 2 to rotate with the rotation of the rotation axle. In addition, although the SPR unit 2 shown in this embodiment is a disc-like structure, but it is not limited thereby, i.e. the SPR unit 2 of the present disclosure can be shaped like a rectangle or other polygons. As for the grating structure, the metal layer and the fluid, they are all being formed and used the same as those described in the first embodiment, and thus are not described further herein.

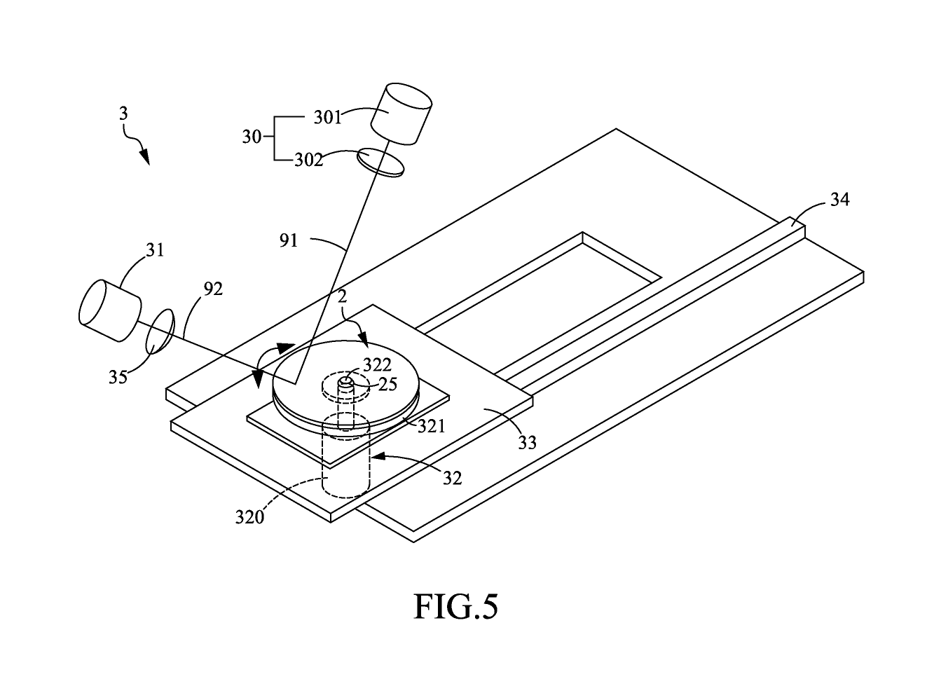

Please refer to FIG. 5, which is a schematic diagram showing a SPR inspection system according to an embodiment of the present disclosure. The SPR inspection system 3 includes: a SPR unit 2, a light source module 30, an optical detection module 31 and a rotation unit 32. It is noted that the SPR unit 3 can be selected from those embodiments disclosed in FIG. 1A, FIG. 3A and FIG. 3C, but in the embodiment of FIG. 5, the SPR unit used is the one shown in FIG. 1A. The light source module 30 is provided for projecting an incident beam 91 onto the at SPR unit 2 for generating a detection beam accordingly. In this embodiment, the light source module 30 is composed of a light source 301 and a polarizer 302. Although the light source in this embodiment is a laser light source, it is not limited thereby that it can be a light emitting diode, a halogen light or whichever capable emitting light. Moreover, although the light source module 30 is composed of the light source 301 and the polarizer 302, it is not limited thereby and thus can be composed of other components as required, such as it can be the assembly of light source, collimation component and polarizer.

The optical detection module 31, being disposed at a side of the light source module 30, is used for receiving the detection beam 92 reflected from the SPR unit 2. It is noted that the optical detection module 31 can be composed of: a device selected from the group consisting of: a charge coupled device (CCD), a complementary metal-oxide-semiconductor (CMOS), a photo detector integrated circuit (PDIC); and other optical components, such as lens 35 and polarizer.

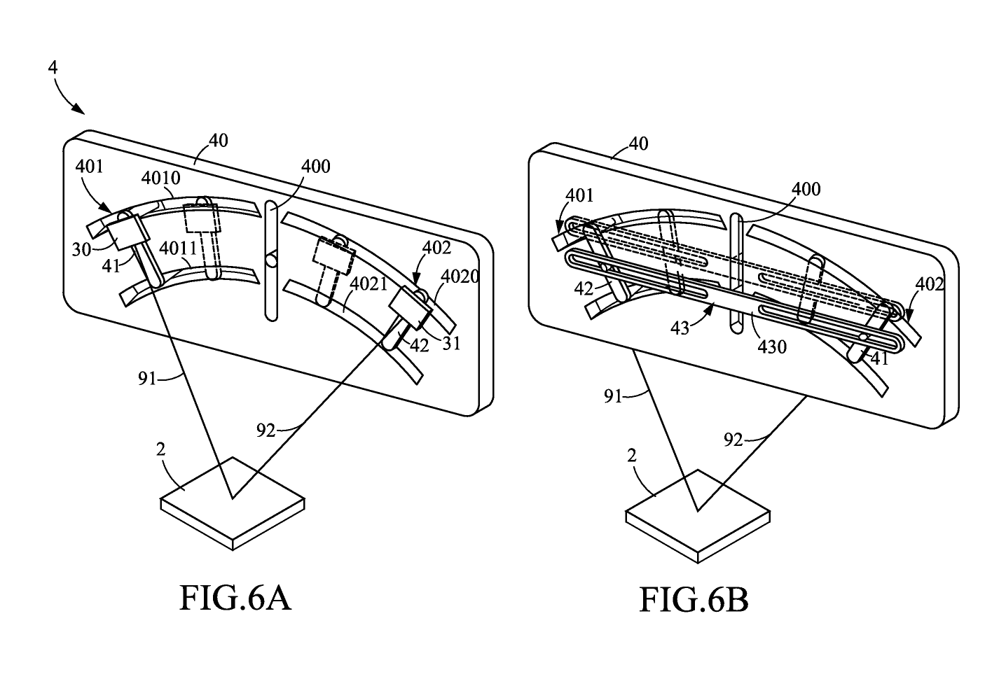

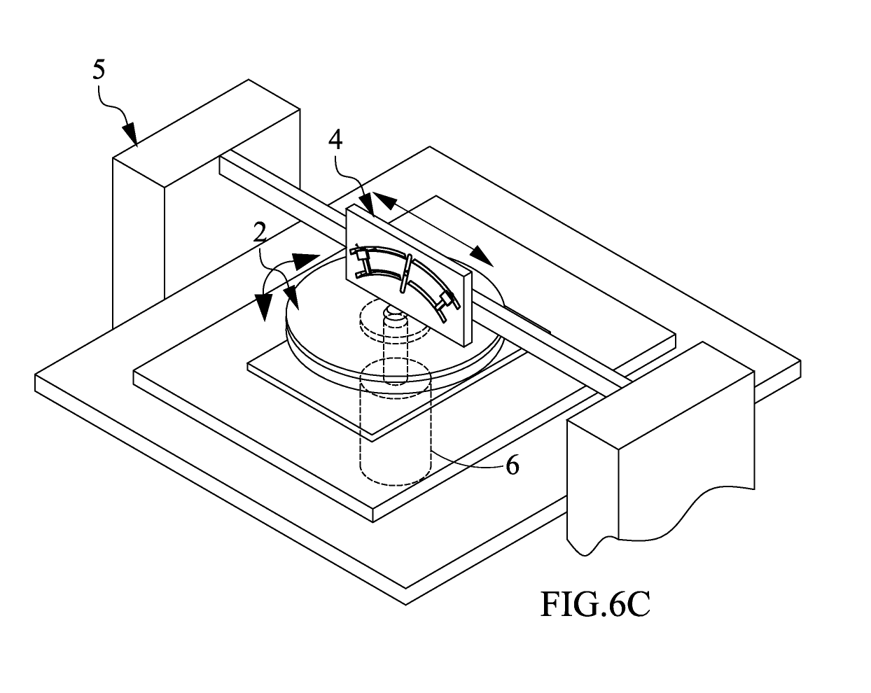

The light source module 30 and the optical detection module 31 are mounted on an angle adjustment device, as the one shown in FIG. 6A and FIG. 6B. The angle adjustment device is coupled with the light source module 30 and the optical detection module 31 so as to adjust an included angle sandwiched between the two modules and thus enable the optical detection module 31 to be positioned relative to the light source module 30 for optimizing the sensitivity of the optical detection module 32 with respect to the SPR effect of the SPR unit 2.

In this embodiment, the angle adjustment device 4 includes a panel 40, a first arm 41, a second arm 42 and a driver 43. The panel 40 is formed with a guide slot 400, a first sliding chute 401 and a second sliding chute 402, whereas the first sliding chute 401 is composed of a pair of first sub-chutes 4010, 4011 of the same curvature, and similarly the second sliding chute 402 is composed of a pair of second sub-chutes 4020, 4021 of the same curvature. The first arm 41, being mounted with the light source module 30, is slidably coupled to the pair of first sub-chutes 4010, 4011; and the second arm 42, being mounted with the optical detection module 31, is slidably coupled to the pair of second sub-chutes 4020, 4021. In addition, the driver 43 is coupled to the first arm 40 and the second arm 42, by that the first arm 40 and the second arm 42 can be driven to slide respectively guided by the first sliding chute 401 and the second sliding chute 402, and thus, the included angle between the light source module 30 and the optical detection module 31 is changed accordingly.

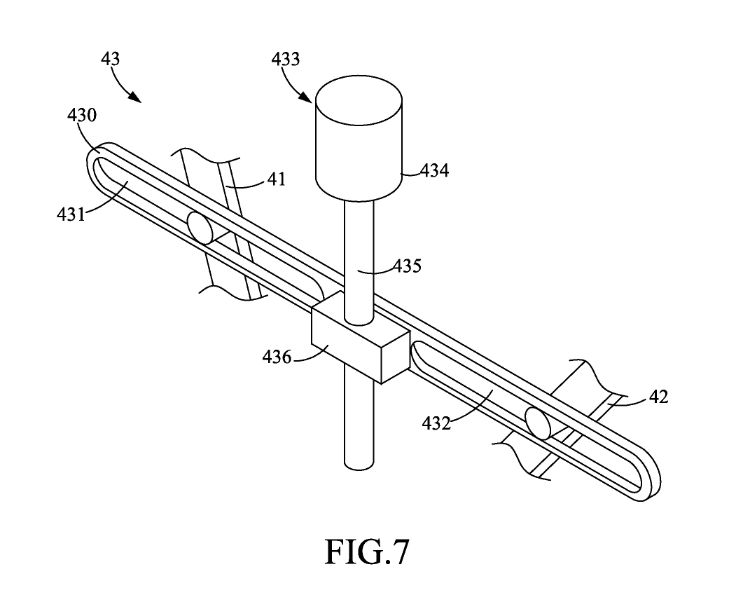

Please refer to FIG. 7, which is a schematic diagram showing a driver for the angle adjustment device of the present disclosure. In FIG. 7, the driver 43 is configured with a rod 430 having two slots 431, 432 formed at the opposite ends thereof, and the rod 430 is coupled to the guide slot 400 at the middle thereof while being slidably coupled to the first arm 41 and the second arm 42 respectively by the two slots 431, 432. Moreover, the driver 43 further comprises a second linear displacement unit 433, which is used for driving the base 43 to move and thus bring along the rod to perform a linear displacement movement. It is noted that the second linear displacement unit 433 can be composed of a motor 434 and a leading screw 435 in a manner that the motor 434 is coupled to the leading screw 435 while the leading screw 435 is fixedly screw on the base 436 of the rod 430. It is noted that the embodiment shown in FIG. 7 is for illustration, and the present disclosure is not limited thereby so that linear displacement movement can be driven by the use of a linear motor or a hydraulic cylinder.

Please refer to FIG. 6A and FIG. 6B for illustrating the operation of the present disclosure. As the light source module 30 is mounted on the first arm 41 and the optical detection module 31 is mounted on the second arm 42, the light source module 30 is positioned for projecting an incident beam 91 onto the SPR unit 2; and the optical detection module 31 is positioned for receiving a detection beam 92 reflected from the SPR unit 2. For changing the angle between the light source module 30 and the optical detection module 31, the rod 430 is brought to move linearly upward or downward. If the rod 430 is brought to move linearly upward and as the rod 430 is coupled to the guide slot 400, the first arm 41 and the second arm 42, the upward moving rod 430 will push the first arm 41 and the second arm 42 to move upward as well. Moreover, as the first arm 41 and the second arm 42 are respectively coupled to the first sliding chute 401 and the second sliding chute 402, the upward movements of the first arm 41 and the second arm 42 will be defined to sliding into their corresponding first sliding chute 401 and the second sliding chute 402, and thus, causing the included angle between the first arm 41 and the guide slot 400 as well as the included angle between the second arm 42 and the guide slot 400 to be decreased. On the other hand for increasing the included angles, the rod 430 should be driven to move downward. Please refer to FIG. 6C, which is a schematic diagram showing how an angle adjustment device is being arranged according to an embodiment of the present disclosure. In FIG. 6C, the angle adjustment device 4 is mounted on a third linear displacement unit 5, which is provided for carrying the angle adjustment device 4 while capable of performing an at least one-dimensional linear movement for adjusting the position of the angle adjustment device 4. As shown in FIG. 6, the SPR unit 2 is disposed on a rotation unit 6, by that the SPR unit 2 is rotated along with the rotation of the rotation unit 6. It is noted that the third linear displacement unit 5 shown in FIG. 6C is a linear motor, but it is not limited thereby that it can be an assembly of screw rod and motor.

As shown in FIG. 5, the rotation unit 32 is composed of a rotation driver 320 and a platform 321. In this embodiment, the rotation driver can be a device selected from the group consisting of: a servo motor, a step motor and the like. The platform 321, being connected to the output shaft of the rotation driver 320, is formed with a protrusion 322 in a manner that it can be fitted into the opening 25 of the SPR unit 2 so as to fixedly stationing the SPR unit 2 on the platform 321. As soon as the platform 321 is driven to rotate by the rotation driver 320, the SPR unit 2 mounted on the platform 321 will be rotate with the rotation of the platform 321 as well, by that a centrifugal force will be generated for forcing the fluid in the SPR unit 2 to flow from the storage wells 2013 to the waste fluid wells 2014 through the grooves 2012 and the inspection regions 2017, as shown in FIG. 1C. Moreover, the rotation unit 33 is further being disposed on a movable carrier 33, which is slidably coupled to a first linear displacement unit 34. Accordingly, the movable carrier 33 can be driven to perform a linear movement by the first linear displacement unit 34 and thus the position of the rotation unit 32 is changed.

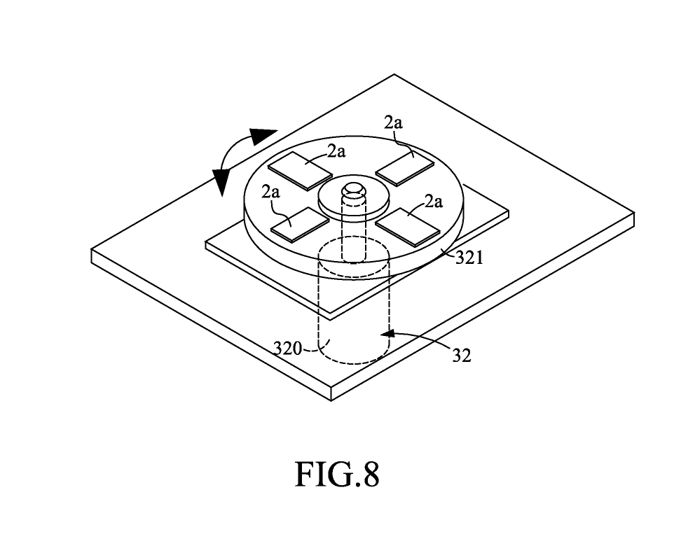

In this embodiment, the first linear displacement unit can be a linear motor or an assembly of screw rod and motor, whichever is capable of producing power for causing a linear movement; and as those are known to those skilled in the art, they will not be described further herein. It is noted that the linear movement enabled by the first linear displacement unit 34 can be a one-dimensional linear movement, a two-dimensional linear movement or above. Please refer to FIG. 8, which is a schematic diagram showing how a SPR unit is arranged according to an embodiment of the present disclosure. As shown in FIG. 8, there are four rectangle-shaped SPR units 2a being placed on the carrying platform 321, where they are rotated along with the rotation of the carrying platform 321 for subjecting the four SPR units 2a respectively with a centrifugal force.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A surface plasmon resonance (SPR) unit, comprising:
a microchannel unit, having at least one microchannel; and
at least one grating structure, each configured with a metal layer and each being respectively disposed inside the at least one microchannel.

2. The SPR unit of claim 1, wherein the microchannel unit further comprises: a microchannel layer, configured with a first surface, a second surface, and at least one groove.

3. The SPR unit of claim 2, further comprising:
a cover layer, disposed on the first surface.

4. The SPR unit of claim 2, wherein there are adhesive layers formed respectively on the first surface and the second surface.

5. The SPR unit of claim 3, further comprising:
a substrate, disposed on the second surface while enabling the at least one grating structure to be formed on the substrate at a position corresponding to the at least one groove; and by the forming of the cover layer and the substrate on the microchannel layer, the at least one groove is shaped into the at least one microchannel.

6. The SPR unit of claim 2, wherein each groove is further comprised of: at least one manifold; and at least one inspection region connected to the at least one manifold.

7. The SPR unit of claim 3, wherein each groove is further connected to at least one storage well and at least one waste fluid well.

8. The SPR unit of claim 7, wherein there are expansion slots formed on the cover layer at positions respectively corresponding to the at least one storage well and the at least one waste fluid well while enabling the expansion slot that is arranged at the position corresponding to the at least one storage well to be connected to a loading well.

9. The SPR unit of claim 3, wherein there is a vent hole formed on the cover layer at a position corresponding to the at least one groove.

10. The SPR unit of claim 1, wherein the microchannel unit further comprises:
a substrate, having at least one groove formed thereon.

11. The SPR unit of claim 10, further comprising:
a cover layer, disposed on the substrate in a manner that the at least one groove is shaped into the at least one microchannel by the covering of the cover layer on the substrate.

12. The SPR unit of claim 11, wherein the at least one grating structure is formed on a position selected from the group consisting of: the bottom of the at least one groove and the cover layer.

13. The SPR unit of claim 11, wherein each groove is further comprised of: at least one manifold; and an inspection region connected to the at least one manifold.

14. The SPR unit of claim 11, wherein each groove is further connected to at least one storage well and at least one waste fluid well.

15. The SPR unit of claim 11, wherein there are expansion slots formed on the cover layer at positions respectively corresponding to the at least one storage well and the at least one waste fluid well while enabling the expansion slot arranged at the position corresponding to the at least one storage well to be connected to a loading well.

16. The SPR unit of claim 11, wherein there is a vent hole formed on the cover layer at a position corresponding to the at least one groove.

17. The SPR unit of claim 1, wherein the metal layer is a metal nano-thin film.

18. The SPR unit of claim 1, wherein there is a fluid flowing inside the at least one microchannel.

19. A surface plasmon resonance (SPR) inspection system, comprising:
at least one SPR unit, each further comprising:
a microchannel unit, having at least one microchannel; and
at least one grating structure, each configured with a metal layer and each being respectively disposed inside the at least one microchannel;
a light source module, for projecting an incident beam onto the at least one SPR unit for generating a detection beam accordingly;
an optical detection module, for receiving the detection beam; and
a rotation unit, for carrying the at least one SPR unit and capable of performing a rotation movement for bringing along the at least one SPR unit to rotate accordingly.

20. The SPR inspection system of claim 19, wherein the microchannel unit further comprises: a microchannel layer, configured with a first surface, a second surface, and at least one groove.

21. The SPR inspection system of claim 20, further comprising:
a cover layer, disposed on the first surface.

22. The SPR inspection system of claim 21, further comprising:
a substrate, disposed on the second surface while enabling the at least one grating structure to be formed on the substrate at a position corresponding to the at least one groove; and by the forming of the cover layer and the substrate on the microchannel layer, the at least one groove is shaped into the at least one microchannel.

23. The SPR inspection system of claim 20, wherein there are adhesive layers formed respectively on the first surface and the second surface

24. The SPR inspection system of claim 20, wherein each groove is further comprised of: at least one manifold; and an inspection region connected to the at least one manifold.

25. The SPR inspection system of claim 21, wherein each groove is further connected to at least one storage well and at least one waste fluid well.

26. The SPR inspection system of claim 25, wherein there are expansion slots formed on the cover layer at positions respectively corresponding to the at least one storage well and the at least one waste fluid well while enabling the expansion slot arranged at the position corresponding to the at least one storage well to be connected to a loading well.

27. The SPR inspection system of claim 21, wherein there is a vent hole formed on the cover layer at a position corresponding to the at least one groove.

28. The SPR inspection system of claim 19, wherein the microchannel unit further comprises
a substrate, having at least one groove formed thereon while enabling the bottom of each groove to be formed with the grating structure.

29. The SPR inspection system of claim 28, further comprising:
a cover layer, disposed on the substrate in a manner that the at least one groove is shaped into the at least one microchannel by the covering of the cover layer on the substrate.

30. The SPR inspection system of claim 29, wherein the at least one grating structure is formed on a position selected from the group consisting of: the bottom of the at least one groove and the cover layer.

31. The SPR inspection system of claim 28, wherein each groove is further comprised of: at least one manifold; and an inspection region connected to the at least one manifold.

32. The SPR inspection system of claim 28, wherein each groove is further connected to at least one storage well and at least one waste fluid well.

33. The SPR inspection system of claim 32, wherein there are expansion slots formed on the cover layer at positions respectively corresponding to the at least one storage well and the at least one waste fluid well while enabling the expansion slot arranged at the position corresponding to the at least one storage well to be connected to a loading well.

34. The SPR inspection system of claim 29, wherein there is a vent hole formed on the cover layer at a position corresponding to the at least one groove.

35. The SPR inspection system of claim 19, wherein the metal layer is a metal nano-thin film.

36. The SPR inspection system of claim 19, further comprising:
a first linear displacement unit, for carrying the rotation unit while capable of performing an at least one-dimensional linear movement for adjusting the position of the rotation unit.

37. The SPR inspection system of claim 19, further comprising
an angle adjustment device, coupled with the light source module and the optical detection module so as to adjust an included angle sandwiched between the two modules.

38. The SPR inspection system of claim 37, further comprising:
a second linear displacement unit, coupled to the angle adjustment device while capable of performing an at least one-dimensional linear movement for adjusting the position of the angle adjustment device.

39. The SPR inspection system of claim 37, further comprising:
a third linear displacement unit, for carrying the angle adjustment device while capable of performing an at least one-dimensional linear movement for adjusting the position of the angle adjustment device.
